(19) United States
(12) Patent Application Publication
(10) Pub. No.: US 2013/0137815 A1
(43) Pub. Date: May 30, 2013

(54) INJECTION MOLDED PARTS PRODUCED FROM A POLYMER COMPOSITION COMPRISING POLYAMIDE 410 (PA-410)

(71) Applicants: Eric Willem Van Der Vegte, Echt (NL); Ronald Ligthart, Echt (NL)

(72) Inventors: Eric Willem Van Der Vegte, Echt (NL); Ronald Ligthart, Echt (NL)

(73) Assignee: DSM IP ASSETS B.V., Heerlen (NL)

(21) Appl. No.: 13/641,510

(22) PCT Filed: Apr. 14, 2011
(86) PCT No.: PCT/EP2011/055923

§ 371 Date: Dec. 22, 2012

(30) Foreign Application Priority Data
Apr. 16, 2010 (EP) 10160121.9

(51) Int. Cl. C08L 77/06

(52) U.S. Cl. CPC C08L 77/06
USPC 524/538; 524/606

(57) ABSTRACT

Injection molded polymeric part produced from a polymer composition comprising polyamide 410 (PA-410) and less than 1.5 weight % of a mold release agent. In a preferred embodiment the polymer composition contains less than 1 wt. % of a mold release agent.

The invention relates to an injection molded polymeric part. Injection molded polymeric parts are well known in the art. Injection molding is a manufacturing process for producing parts from thermoplastic and thermosetting polymer compositions as well as elastomeric polymer compositions. The composition is fed into a heated barrel, molten and forced into a mold cavity, where it hardens by cooling in case of a thermoplastic polymer composition or by a chemical reaction in case of a thermosetting polymer composition or an elastomeric polymer composition. After the hardening the part maintains the shape of the mold cavity. In large series production in general the molds are produced from metal, in most instances steel, and are precision-machined to form the features of the part.

Immediately after sufficiently being hardened the parts are released from the mold by opening of the mold and ejecting the part from the cavity of the mold. Ejection often takes place by pushing the article out of the mold by ejecting pins, coming up from the cavity wall, normally in the direction of ejection of the part.

Mold release of the part is a delicate step in the injection molding process.

It is important that the part easily releases from the mold, so that no increase in cycle time of the production of the part takes place. If the part does not release easily, it is even possible that the part is damaged during ejection from the mold. The ejection of the parts is facilitated by almost or even fully completion of the hardening step in the mold, by for example total cooling down of the part. Because of the cooling process the dimensions of the part decrease, due to thermal shrinkage and if applicable due to crystallization of the polymer. However a total cooling down of the part takes a lot of time, so that the cycle time for the production of the part increases to an unacceptable level and it is not any longer possible to produce the parts at an acceptable cost price. Mold release is further enhanced by the addition of a mold release agent to the polymeric material. This however often shows a negative influence on the surface properties of the part. A third possibility is to choose a high release angle fort he part, however this restricts the design freedom of the part.

For all these reasons there is a need for injection molded parts that show favorable release characteristics from the mold they are produced with. Surprisingly such injection molded parts are obtained if the molded parts are produced from a polymer composition comprising polyamide 410 (PA-410) and less than 1.5 weight % of a mold release agent.

In WO 00/09586 parts from the melt, such as for example a fiber, a film, a plate or a molded part in general are mentioned for polyamides consisting essentially of units derived from an aliphatic dicarboxylic acid with 8-14 C-atoms and 1,4-butanediane. However injection molded parts of the polymers are not mentioned specifically, certainly not injection molded parts of PA-410. Furthermore there is no indication given that injection molding products of PA-410 show the favorable mold release characteristics, especially not with a low amount of or even no mold release agent.

With the low amount or even with the total absence of the mold release agent, the injection molded parts from the polymer composition comprising PA-410 according to the invention still show very good mold release characteristics, but also have a very good surface quality. The gloss of the parts may be very high, electrical properties are better, like for instance surface resistance, resistance to tracking etc., flame retardency of the part. A further advantage of a low amount of mold release agent is that the formation of deposits on the surface of the cavity of the mold occur is suppressed or even absent at all.

This is very surprising, since for polymer compositions in general, also polymer compositions based on other polyamides than PA-410, it is generally necessary to use mold release agents, otherwise problems with release injection molded parts from the molds occur.

A mold release agent is a chemical compound that facilitates the release of a part from a mold, preferably by creating a slip effect between the surface of the part and the surface of the mold cavity. Examples of mold release agents include fatty acids, fatty acid metals salts, fatty acid esters, fatty acid amides, fatty acid soaps, (modified) paraffin waxes, (modified) polyolefin waxes. Preferably, the mold release agents are chosen from the group of fatty acids, such as for example metal salts of stearates especially sodium, zinc or calcium stearate or montanate, and polyetheylene wax and an fatty acid amide such as ethylen-bis-stearamide or combinations thereof.

PA-410 is a polyamide containing monomer units derived from a dicarboxylic acid with 10 carbon atoms and a diamine with 4 carbon atoms. Preferably as the dicarboxylic acid 1,10 decandioic acid is used. As the diamine preferably 1,4-butanediane is used. PA-410 may comprise up to 30 wt. % of further monomeric units, for example dicarboxylic acids with less than 10 carbon atoms or diamines with more than 4 carbon atoms. Preferably the PA-410 used in the injection molded part according to the invention comprises at least 80 wt. % of the dicarboxylic acid with a chain of 10 carbon atoms between the carboxylic acid groups and a the diamine with 4 carbon atoms, more preferably at least 90 wt. %, even more preferably at least 95 wt. %, even more preferably at least 99 wt. %, most preferably at least 99.9 wt. %.

Next to PA-410 the polymer composition of the injection molded part according the invention may comprise one or more further polymers. The polymeric composition of the injection molded part according to the invention may contain:

A. 20 100 parts by weight (pbw) of PA-410 and
B. One or more further polymers,
whereby A and B add up to 100 pbw.

Preferably A is 40-100 parts by weight of PA-410, more preferably 60-100 parts. Most preferably the polymeric part of composition consists of PA-410, which means that all 100 parts of the polymeric part of the composition are made up by PA-410.

Examples of the further polymers include polyolefins, styrene polymers and copolymers and especially further polyamides, for example PA-46, PA6-10, PA-510, and preferably PA-6 and PA-66.

The polymer composition of the molded part according to the invention may comprise reinforcing fibers, like aramid fibers, carbon fibers, glass fibers like for example S-glass fibers and E-glass fibers. Preferably the composition contains glass fibers. The composition may contain between 2 and 70 parts by weight of glass fibers at 100 parts of A and B. Preferably the composition contains 15-60 wt. % of glass fibers. As glass fibers normally chopped glass fibers are used. The compositions also may contain one or more fillers, for example mica, talcum, wolastonite, calcium carbonate etc.

The polymer composition may further comprise the usual additives, as for example stabilizers, processing adds, nucleation additives etc. Preferably the composition contains at most 20 pbw of further additives at 100 pbw of component A+B, more preferably at most 10 pbw, even more preferably at most 5 pbw, most preferably at most 2 pbw.

Preferably the polymer composition of the injection molded part according to the present invention contains less than 1.25 (weight) wt. % more preferably less than 1 wt. %, even more preferably less than 0.75 wt. %, even more preferably less than 0.5 wt. %, even more preferably leas than 0.3 wt. %, even more preferably less than 0.1 wt. % of a mold release agent. Most preferably the polymer composition does not contain any mold release agent at all.

The polymer composition of the injection molded parts according to the invention may be produced by making in a first step a dry blend of powder or granules of component A and further compounds, like for example component B, the reinforcing fibers and the further additives, the further additives eventually provided as a master batch. Thereafter granulate of the composition might be produced by using an apparatus for melt mixing, for example a twin screw extruder. The granulate of the composition can be fed to an injection molding apparatus for producing the injection molded parts. The invention is especially useful for larger part, since mold release of larger parts is especially critical. Therefore the injection molded part according to the invention has preferably a weight of at least 100 grams, more preferably 200 grams, even more preferably at least 400 grams, most preferably at least 800 grams.

Because of the favorable mold release characteristics the part according to the invention has an improved freedom of design, since the applied release angles in the design are less critical. This is especially beneficial for parts with complex designs. A release angle is the angle between a surface plane of the part and the direction of ejection of the part from the mold. The invention is therefore especially beneficial for parts according to the invention, not comprising any glass fibers, comprising one or more release angles of less than 1° 30′, more preferably less than 1°, even more preferably less than 50′, even more preferably less than 40′, even more preferably less than 30′, even more preferably less than 25′.

The invention is therefore especially beneficial for parts according to the invention, comprising glass fibers, comprising one or more release angles of less than 30′, more preferably less 25′, even more preferably less than 20′, even more preferably less than 15′.

Examples of parts where such release angles are beneficial, are for example housings, electric and electronic parts, car parts.

### EXAMPLE 1

Polymer granulate consisting of PA-410, not containing any mould release agent, was injection molded at an Engel 110 injection molding machine into a mould for test bar for determining the tensile strength according to ISO 527-1A. The melt temperature during injection was 50° C. above the melting point of the polymer, the injection time was 1 sec. and the mould temperature was 80° C. The test bar was ejected 60 seconds after injection. The test bar was smoothly ejected, without any damages or sticking in the mould.

Comparative experiment A

As example 1, however granulate of PA-6, containing no mould release agent was used. It was not possible to eject the test bar, without damaging the test bar or with sticking of the test bar in the mould. Sticking of the test bar was observed, by a cracking noise during ejection of the test bar.

Comparative experiment B

As example 1, however granulate of PA-66 without any mould release agent was used. It was not possible to eject the test bar, without damaging the test bar or with sticking of the test bar in the mould. Sticking of the test bar was observed, by a cracking noise during ejection of the test bar.

Comparative example C

As example 1, however granulate of PA-46 without any mould release agent was used. It was not possible to eject the test bar, without damaging the test bar or with sticking of the test bar in the mould. Sticking of the test bar was observed, by a cracking noise during ejection of the test bar.

1. Injection molded polymeric part characterized in that the part is produced from a polymer composition comprising polyamide 410 (PA-410) and less than 1.5 weight % of a mold release agent.

2. Injection molded part according to claim 1, wherein the polymer composition contains
A. 20-100 parts by weight (pbw) PA-410
B. One or more further polymers,
Whereby A and B add up to 100 pbw.

3. Injection molded part according to claim 1, wherein the polymer composition contains less than 1 wt. % of a mold release agent.

4. Injection molded part according to claim 1, wherein the polymer composition contains less than 0.5 wt. % of a mold release agent.

5. Injection molded part according to claim 1, wherein the polymer composition contains less than 0.3 wt. % of a mold release agent.

6. Injection molded part according to claim 1, wherein the part has a weight of at least 100 grams.

7. Injection molded part according to claim 1, wherein the part has a weight of at least 200 grams.

8. Injection molded part according to claim 1, wherein the polymer composition does not contain glass fibers and wherein the part comprises one or more release angles of less than 1° 30′.

9. Injection molded part according to claim 1, wherein the polymer composition does not contain glass fibers and wherein the part comprises one or more release angles of less than 1°.

10. Injection molded part according to claim 1, wherein the polymer composition does not contain glass fibers and wherein the part comprises one or more release angles of less than 50′.

11. Injection molded part according to claim 1, wherein the polymer composition contains glass fibers and wherein the part comprises one or more release angles of less than 30′.

12. Injection molded part according to claim 1, wherein the polymer composition contains glass fibers and wherein the part comprises one or more release angles of less than 25′.
